(19) United States
(12) Patent Application Publication
(10) Pub. No.: US 2002/0104008 A1
(43) Pub. Date: Aug. 1, 2002

(54) Method and system for securing control-device-lun-mediated access to luns provided by a mass storage device

(76) Inventors: Robert A. Cochran, Rocklin, CA (US); Gregory D. Dolkas, Auburn, CA (US)

Correspondence Address: HEWLETT-PACKARD COMPANY, Intellectual Property Administration, P.O. Box 272400, Fort Collins, CO, 80527-2400, US

(21) Appl. No.: 09/726,852

(22) Filed: Nov. 30, 2000

(51) Int. Cl. H04L 9/32

(52) U.S. Cl. 713/200

(57) ABSTRACT

Method and system for securing control-device LUN-mediated operation requests within a mass storage device coupled to one or more remote computers via a communications medium. Control-device-mediated operations represent a class of operations that may manipulate or access a number of different LUNs that are specified as part of the requests for the operations. The present invention employs an access table that a controller within a mass storage device may consult in order to authorize a request for an operation directed to a specific target CDLUN, and employs a supplementary access table to check that the target CDLUN is authorized to access or manipulate any other LUNs specified as part of the request.

### TECHNICAL FIELD

The present invention relates to security mechanisms employed within mass storage devices and, in particular, to a method and system for securing access to logical units provided by a mass storage device to remote computers during indirect access of the logical units by the remote computers via a control-device logical unit.

### BACKGROUND OF THE INVENTION

The present invention relates to insuring that a remote computer may gain access only to that data stored within the mass storage device for which a remote computer has access privileges. The present invention is described and illustrated with reference to an embodiment included in a disk array controller that services I/O requests from a number of remote computers. However, alternative embodiments of the present invention may be employed in controllers of many other types of storage devices as well as in a general electronic server applications.

FIG. 1 is a block diagram of a standard disk drive. The disk drive 101 receives I/O requests from remote computers via a communications medium 102 such as a computer bus, fibre channel, or other such electronic communications medium. For many types of storage devices, including the disk drive 101 illustrated in FIG. 1, the vast majority of I/O requests are either READ or WRITE requests. A READ request requests that the storage device return to the requesting remote computer some requested amount of electronic data stored within the storage device. A WRITE request requests that the storage device store electronic data furnished by the remote computer within the storage device. Thus, as a result of a READ operation carried out by the storage device, data is returned via communications medium 102 to a remote computer, and as a result of a WRITE operation, data is received from a remote computer by the storage device via communications medium 102 and stored within the storage device.

The disk drive storage device illustrated in FIG. 1 includes controller hardware and logic 103 including electronic memory, one or more processors or processing circuits, and controller firmware, and also includes a number of disk platters 104 coated with a magnetic medium for storing electronic data. The disk drive contains many other components not shown in FIG. 1, including read/write heads, a high-speed electronic motor, a drive shaft, and other electronic, mechanical, and electromechanical components. The memory within the disk drive includes a request/reply buffer 105 which stores I/O requests received from remote computers and an I/O queue 106 that stores internal I/O commands corresponding to the I/O requests stored within the request/reply buffer 105. Communication between remote computers and the disk drive, translation of I/O requests into internal I/O commands, and management of the I/O queue, among other things, are carried out by the disk drive I/O controller as specified by disk drive I/O controller firmware 107. Translation of internal I/O commands into electromechanical disk operations in which data is stored onto, or retrieved from, the disk platters 104 is carried out by the disk drive I/O controller as specified by disk media read/write management firmware 108. Thus, the disk drive I/O control firmware 107 and the disk media read/write management firmware 108, along with the processors and memory that enable execution of the firmware, compose the disk drive controller.

Individual disk drives, such as the disk drive illustrated in FIG. 1, are normally connected to, and used by, a single remote computer, although it has been common to provide dual-ported disk drives for use by two remote computers and multi-port disk drives that can be accessed by numerous remote computers via a communications medium such as a fibre channel. However, the amount of electronic data that can be stored in a single disk drive is limited. In order to provide much larger-capacity electronic data storage devices that can be efficiently accessed by numerous remote computers, disk manufacturers commonly combine many different individual disk drives, such as the disk drive illustrated in FIG. 1, into a disk array device, increasing both the storage capacity as well as increasing the capacity for parallel I/O request servicing by concurrent operation of the multiple disk drives contained within the disk array.

FIG. 2 is a simple block diagram of a disk array. The disk array 202 includes a number of disk drive devices 203, 204, and 205. In FIG. 2, for simplicity of illustration, only three individual disk drives are shown within the disk array, but disk arrays may contain many tens or hundreds of individual disk drives. A disk array contains a disk array controller 206 and cache memory 207. Generally, data retrieved from disk drives in response to READ requests may be stored within the cache memory 207 so that subsequent requests for the same data can be more quickly satisfied by reading the data from the quickly accessible cache memory rather than from the much slower electromechanical disk drives. Various elaborate mechanisms are employed to maintain, within the cache memory 207, data that has the greatest chance of being subsequently re-requested within a reasonable amount of time. The disk array controller 206 may also elect to store data received from remote computers via WRITE requests in cache memory 207 in the event that the data may be subsequently requested via READ requests or in order to defer slower writing of the data to physical storage medium.

Electronic data is stored within a disk array at specific addressable locations. Because a disk array may contain many different individual disk drives, the address space represented by a disk array is immense, generally many thousands of gigabytes. The overall address space is normally partitioned among a number of abstract data storage resources called logical units (“LUNs”). A LUN includes a defined amount of electronic data storage space, mapped to the data storage space of one or more disk drives within the disk array, and may be associated with various logical parameters including access privileges, backup frequencies, and mirror coordination with one or more LUNs. LUNs may also be based on random access memory (“RAM”), mass storage devices other than hard disks, or combinations of memory, hard disks, and/or other types of mass storage devices. Remote computers generally access data within a disk array through one of the many abstract LUNs 208-215 provided by the disk array via internal disk drives 203-205 and the disk array controller 206. Thus, a remote computer may specify a particular unit quantity of data, such as a byte, word, or block, using a bus communications media address corresponding to a disk array, a LUN specifier, normally a 64-bit integer, and a 32-bit, 64-bit, or 128-bit data address that specifies a LUN, and a data address within the logical data address partition allocated to the LUN. The disk array controller translates such a data specification into an indication of a particular disk drive within the disk array and a logical data address within the disk drive. A disk drive controller within the disk drive finally translates the logical address to a physical medium address. Normally, electronic data is read and written as one or more blocks of contiguous 32-bit or 64-bit computer words, the exact details of the granularity of access depending on the hardware and firmware capabilities within the disk array and individual disk drives as well as the operating system of the remote computers generating I/O requests and characteristics of the communication medium interconnecting the disk array with the remote computers.

The disk array controller within the disk array interacts with remote computers through an interface implemented within the disk array controller. This interface is analogous to a high-level protocol of a computer networking system or to a function-call interface provided by an operating system to application programs and to human users. The interface provided by a disk array controller logically comprises a set of operations that can be requested by a remote computer accessing the disk array through a communications medium. In order to request an operation, a remote computer provides a number of different types of information, commonly including the communications-medium address of the remote computer, an indication of the type of operation being requested by the remote computer, parameters particular to the requested operation, such as a data address, and a target LUN against which the disk array controller should carry out the operation. Thus, for example, to carry out a disk write operation, a remote computer needs to specify the location of the data to be written, an address to which the data is to be written, and an identifier of a LUN that provides an address space including the address to which the data should be written.

There are, however, a number of different types of operations that a remote computer may request of a disk array controller that are either non-LUN-based operations, or operations that span multiple LUNs. As one example, a remote computer may request that a disk array controller mirror a first LUN to a second LUN. When a first LUN is mirrored to a second LUN, the disk array controller automatically executes any writes directed to the first LUN to both the first and second LUNs, so that the second LUN is a faithful mirror copy of the first LUN. Thus, a remote computer, in order to request that the disk array controller mirror a first LUN to second LUN, needs to specify both LUNs in a request for execution of the mirroring operation. After the initial mirror linkage is established, the remote computer can simply write to the first, primary LUN and be assured that the data will be internally copied to the secondary, mirror LUN. As another example, a remote computer may wish to direct a disk array controller to automatically backup a set of LUNs at specified time intervals to a specified backup device.

To reconcile the fact that a number of operations provided to a requesting remote computer by a disk array controller may involve multiple LUNs to the fact that, in general, in invoking any particular operation through many current disk array controller interfaces, a remote computer must specify a single target LUN, a type of virtual LUN known as a control-device LUN (“CDLUN”) is provided by disk array controllers as part of the interface through which remote computers invoke operations. CDLUNs are essentially points of access to various operations provided by, and carried out by, a disk array controller. Thus, to specify that a first LUN should be mirrored to a second LUN, a remote computer invokes a mirroring operation and specifies, as the target of the operation, a particular CDLUN. CDLUNs provide indirect memory-mapped access to LUN pair control operations within the array. Control operations directed to specific logical address offsets within the CDLUN are, by definition, directed to the LUN within the array associated with that offset.

A disk array controller may additionally provide, as part of the interface provided to remote computers, various security mechanisms that allow a particular remote computer or group of remote computers to acquire and maintain exclusive access to one or more LUNs. By doing so, a remote computer, or group of remote computers, may shield private data from access, and from potential corruption, by unauthorized entities. Disk arrays were initially developed for use within a single organization, and security to data stored within a disk array was generally obtained by physical isolation of the disk array within a computer room and connection of the disk array to only trusted computers within the organization. However, with the increasing sizes and complexities of disk arrays, and the greatly increased capabilities of communications media, such as the fibre channel, it is becoming increasingly common for disk arrays to be partitioned among a number of different remote organizations which access the data stored within the disk arrays via a communications medium, such as the fibre channel.

As a first level of security, disk arrays commonly partition access to LUNs via a centrally stored access table managed by the disk array controller. The access table commonly stores entries, each entry comprising an indication of a LUN, an indication of a port, and a unique identifier of a remote computer. When the disk array controller receives a request from a remote computer to carry out an operation with a specified target LUN via a particular communications port, the disk array controller looks in the access table for an entry containing indications of the target LUN, the port through which the request was received, and a unique identifier matching that of the remote computer from which the request was received. If such an entry is found, then the disk array controller allows the operation to proceed. On the other hand, if no such entry is found, then the disk array controller returns an indication that no such storage LUN exists to the requesting remote computer. The access table is normally populated with entries via a console interface by a systems administrator or network manager. Thus, the systems manager or network administrator partitions access to LUNs among remote computers by setting up and maintaining an access table within the disk array that is used by the disk array controller to check each incoming request for execution of an operation by the disk array controller for proper authorization.

Unfortunately, the class of operations which span multiple LUNs, and which require specification of a target CDLUN, as described above, are currently not adequately secured by the access table method described above. Currently, the disk array controller checks a requested operation that specifies a target CDLUN by checking whether an entry in the access table includes a unique identifier of the requesting remote computer, an indication of the CDLUN, and an indication of the port through which the request was received. However, the disk array controller does not subsequently check whether the requesting remote computer is authorized to access any additional LUNs specified as part of the request for execution of the operation. For example, if a remote computer requests, via a particular target CDLUN, that a first LUN be mirrored to a second LUN, the disk array controller only checks to see whether or not the remote computer is authorized to access the target CDLUN, but does not subsequently check to see whether the remote computer is authorized to access the additionally specified first and second LUN.

The absence of authorization checking by the disk array controller for LUNs, indirectly accessed via a CDLUN, additionally specified as part of a request for execution of an operation against a target CDLUN represents a rather large potential for security breaches within disk array mass storage devices and for the remote computers storing and retrieving data from disk arrays. It is possible for a remote computer belonging to a first organization to mistakenly or maliciously specify a LUN belonging to the second organization as part of a mirror operation requested by the first organization. Similarly, a remote computer of the first organization may mistakenly or maliciously incorporate a LUN belonging to a second organization into a set of LUNs specified as part of a request for automatic backup. In such cases, the first organization may mistakenly or maliciously direct requests for operations to the disk array that result in either corruption of the data stored within the disk array that belongs to a second organization or that result in unauthorized copying of data that belongs to a second organization.

Disk array controllers are commonly implemented with firmware and in logic circuits. These implementations are not easily changed, as are software program implementations. Furthermore, because of hardware and internal memory constraints, the elaborate security methodologies and protocols commonly found in general-purpose operating systems and network protocols may be prohibitively expensive and difficult to implement as part of a firmware disk array controller implementation. For these reasons, designers, manufacturers, and user of disk arrays have recognized the need for a relatively easily implemented additional security mechanism for preventing access of LUNs to unauthorized remote computers via operations carried out against target CDLUNs.

### SUMMARY OF THE INVENTION

In one embodiment of the present invention, a disk array controller uses two access tables in order to check for authorization of an operation requested by a remote computer, directed to a target CDLUN, that includes specification of additional LUNs. First, the disk array controller determines whether there is an entry in a first access table having indications of a LUN, port, and remote computer identifier equal to the specified target CDLUN of the request, the port through which the request was received, and the unique identifier of the remote computer from which the request was received. When such an entry is present in the first access table, then the disk array controller assumes that the requesting remote computer is authorized to access the target CDLUN. Next, the disk array controller checks a second, supplemental access table to determine if, for each additional LUN specified as part of the request for execution of the operation, there exists an entry containing an indication of the additional LUN paired with an indication of the specified target CDLUN for the operation. Only when the disk array controller finds such an entry in the supplemental access table for each additional LUN specified in the request for execution of the operation does the disk array controller authorize execution of the operation.

For the many non-CDLUN-mediated operations, such as common read and write operations, authorization checking by the disk array controller is unchanged. For such an operation to proceed, the disk array controller must find a corresponding entry in the access table. The disk array controller employs the two-level access table and supplemental access table authorization check only for requests for operations that specify a target CDLUN and that include specifications of additional LUNs, such as a request for LUN mirroring.

Thus, in order to successfully request an operation that specifies a target CDLUN and that includes specification of additional LUNs, a requesting remote computer must be authorized to access the specified target CDLUN, and the target CDLUN must be authorized to access each additionally specified LUN. Both the access table and the supplemental access table are populated, organized, and maintained by a system administrator or network administrator interacting with the disk array controller via a console or remotely through a secure interconnection. Because authorization checking of the many operations that specify target LUNs, rather than target CDLUNs, is not changed, and because the implementation of a supplemental access table and the authorization check employing the supplemental access table are nearly identical to the current implementations of the access table and authorization check employing the access table, the described embodiment of the present invention is economically and relatively easily implemented as part of the firmware implementation of a disk array controller.

### BRIEF DESCRIPTION OF THE DRAWINGS

FIG. 1 is a block diagram of a standard disk drive.

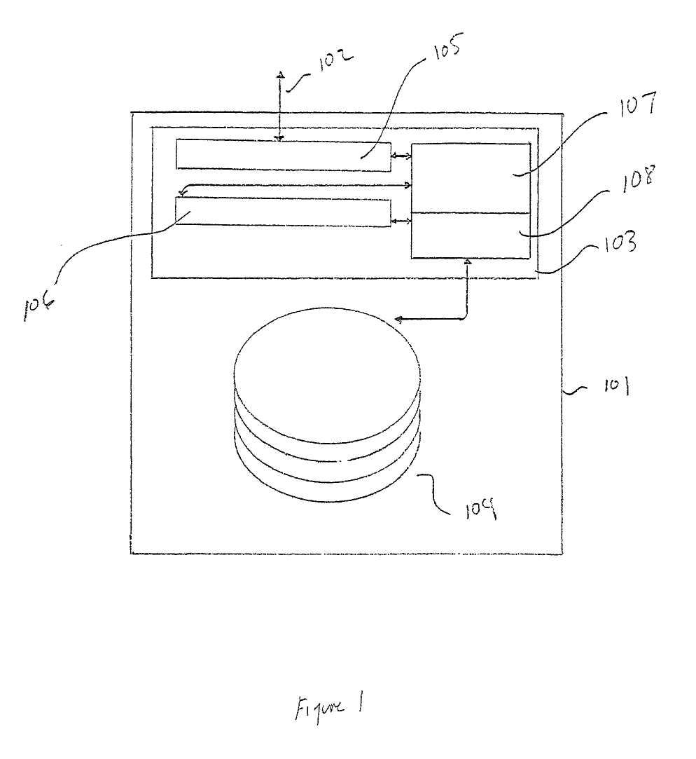

FIG. 2 is a simple block diagram of a disk array.

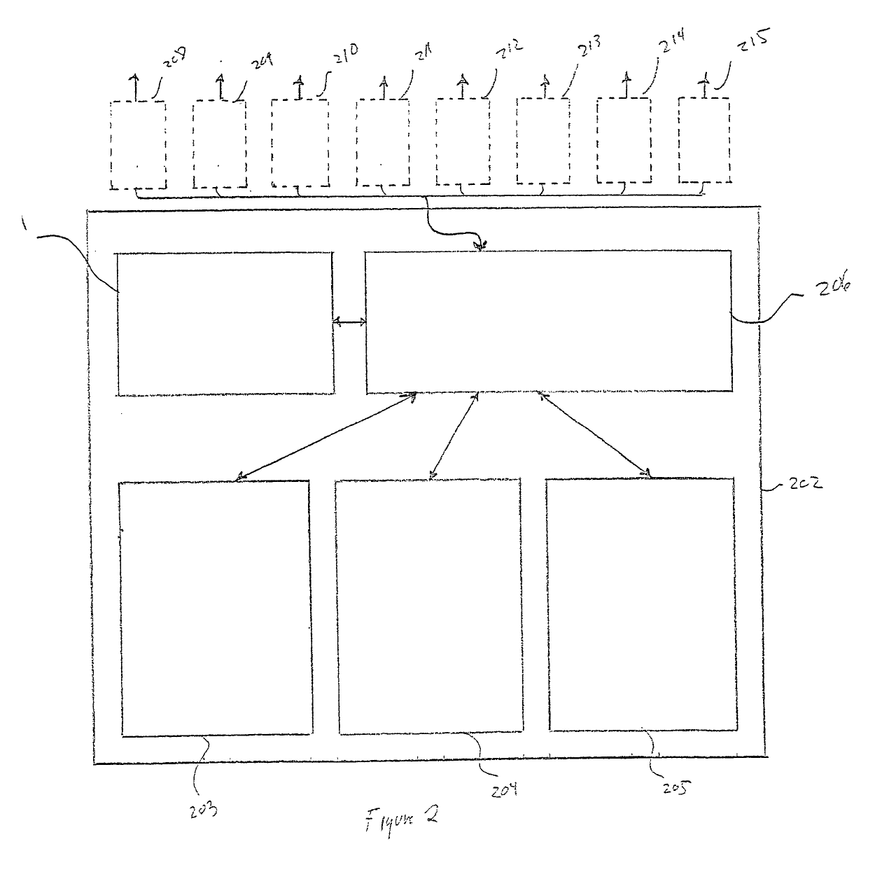

### DETAILED DESCRIPTION OF THE INVENTION

The present invention is related to security measures undertaken by a disk array controller that checks authorization of a requesting remote computer for requested operations. In certain current firmware implementations of disk array controllers, as explained previously, the disk array controller searches an access table for an entry that includes an indication of the target LUN specified as part of the request, an indication of the port through which the request was received, and a unique identifier of the requesting remote computer. When such an entry is found in the access table, the disk array controller continues to carry out the requested operation, but when no such entry is found, the disk array controller returns an indication to the requesting remote computer that no such storage LUN exists. As previously discussed, this method of authorization is inadequate for a class of operations provided by the disk array controller directed to a specified target CDLUN and involving additional specified LUNs. As previously discussed, operations that request mirroring of a first LUN to a second LUN, or of a first group of LUNs to a second group of LUNs, or operations that request a group of LUNs be automatically backed up to a specified backup device, are examples of operations that include a target CDLUN along with specification of additional LUNs. Currently, this class of operation is authorized by the disk array controller when the requesting remote computer is authorized to access the target CDLUN, regardless of whether the requesting remote computer is authorized to access the additionally specified LUNs. A mistaken or malicious remote computer can easily gain access to LUNs to which the mistaken or malicious remote computer does not have access privileges via a target CDLUN for which the mistaken or malicious remote computer does have access privileges.

In order to close this potentially large security hole within current disk array controller implementations, one embodiment of the present invention employs a second, supplemental access table for those operations that are requested by specification of a target CDLUN along with additional LUNs. The supplemental access table has entries that each include an indication of a CDLUN and an indication of a non-CDLUN. The presence of a CDLUN/LUN pair within the supplemental access table indicates that the CDLUN may access the LUN. In order for a remote computer to be authorized to request an operation by specifying a target CDLUN along with additional LUNs, the remote computer must be authorized to access the target CDLUN via an entry in the access table, and the target CDLUN must be authorized to access each additional LUN specified in the request via entries in the supplemental access table.

As will be discussed in detail, below, the described embodiment of the present invention is economically and relatively easily implemented within the firmware implementation of a disk array controller. First, the authorization checking methodology for the bulk of operations provided by the disk array controller that include target LUNs rather than target CDLUNs is unchanged. The changes to the current methodology for authorization checking relate only to that class of operations that are directed to a specified target CDLUN and that involve additional specified LUNs. For that class of operation, a two-part authorization is used, first part identical to the current authorization methodology, and implementation of the second part quite similar to the current authorization methodology.

One embodiment of the present invention is discussed in detail, below, with reference to a C++-like pseudocode implementation. A C++-like pseudocode implementation is chosen for clarity and for illustrative purposes. In general, disk array controllers are implemented in firmware or directly in logic circuits. Because firmware implementations as well as logic circuit implementations are, by modern techniques, designed and implemented by compilation of high-level program-like specifications, it is entirely appropriate to illustrate implementation of the present invention in terms of pseudocode.

The following C++-like pseudocode implementation illustrates the current security mechanism used within certain disk array controllers as well as one embodiment of the current invention. First, several constants and three class declarations representing identifiers for LUNs, ports, and servers are provided below, a server in the pseudocode implementation equivalent to the more general notion of a remote computer:

| | |
|---|---|
| 1 | const int WWW_name_length = 20; |
| 2 | const int TableLength = 1000; |
| 3 | class LUN |
| 4 | { |
| 5 | private: |

| | |
|---|---|
| 6 | int name |

| | |
|---|---|
| 7 | public: |

| 8 | int getVal() | | {return name;}; |
|---|---|---|---|
| 9 | LUN& operator=(int I) | | {name = I; return *this;}; |
| 10 | LUN& operator=(LUN& I) | | {name = I.getVal(); return *this;}; |
| 11 | bool | operator==(LUN& I) | {return (I.getVal() == name);}; |
| 12 | bool | operator<(LUN& I) | {return (name < I.getVal());}; |
| 13 | bool | operator>(LUN& I) | {return (name > I.getVal());}; |

| | | |
|---|---|---|
| 14 | LUN(LUN& I) | {name = I.getVal();}; |
| 15 | LUN (int I) | {name =I;}; |
| 16 | LUN(); | |

| | |
|---|---|
| 17 | }; |
| 18 | class port |
| 19 | { |
| 20 | private: |

| | |
|---|---|
| 21 | int name |

| | |
|---|---|
| 22 | public: |

| 23 | int getVal() | | {return name;}; |
|---|---|---|---|
| 24 | port& | operator=(int p) | {name = p; return *this;}; |
| 25 | port& | operator=(port& p) | {name = p.getVal(); return *this;}; |
| 26 | bool | operator==(port& p) | {return (p.getVal() == name);}; |
| 27 | bool | operator<(port& p) | {return (name < p.getVal());}; |
| 28 | bool | operator>(port& p) | {return (name > p.getVal());}; |

| | | |
|---|---|---|
| 29 | port(port& p) | {name = p.getVal();}; |
| 30 | port (int p) | {name = p;}; |
| 31 | port(); | |

| | |
|---|---|
| 32 | }; |
| 33 | class server |
| 34 | { |
| 35 | private: |

| | | |
|---|---|---|
| 36 | char | name[WWW_name_length]; |

| | |
|---|---|
| 37 | public: |

| | | |
|---|---|---|
| 38 | char* | getVal() {return name;}; |
| 39 | server& | operator=(char* s); |
| 40 | server& | operator=(server& s); |
| 41 | bool | operator==(server& s); |
| 42 | bool | operator<(server& s); |
| 43 | bool | operator>(server& s); |

| | |
|---|---|
| 44 | server(server& s); |
| 45 | server (char* s); |
| 46 | server(); |

| | |
|---|---|
| 47 | }; |

The constant “WWW_name_length,” declared above on line 1, is an arbitrarily defined length for a character string identifier for a server, or remote computer. The constant “TableLength,” declared above on line 2, is an arbitrary maximum length of an access table. Note that, in an actual implementation, the values arbitrarily assigned to these constants may be quite different, or either or both of server names and access table lengths may have variable lengths.

The class “LUN,” declared above on lines 3-17, represents an indication, or identifier, of a particular LUN. In the pseudocode implementation, a LUN identifier is basically an integer, and the class “LUN” correspondingly includes an integer data member “name,” declared on line 6, above. The member function “getVal,” declared above on line 8, returns the integer value of the data member “name.” Additional function members, declared above on lines 9-13, provide assignment and relational operators that allow one LUN to be assigned to another, a LUN to be assigned the value of an integer, and one LUN to be compared with another LUN. Finally, the class “LUN” includes three constructors, declared above on lines 14-16, that allow a LUN to be constructed to have the value of a different LUN, to have the value of an integer supplied as an argument to the constructor, or that allow a LUN to be constructed without specifying the integer value of the data member “name.” The classes “port” and “server,” declared above on lines 18-32 and 33-47, respectively, similarly represent a port identifier and a server, or remote computer, identifier, respectively. A port is, like a LUN, identified by an integer, and a server, or remote computer, is identified by a character string of length “WWW_name_length.”

Next, two class declarations that define an access table are provided:

| | |
|---|---|
| 1 | class AccessEntry |
| 2 | { |
| 3 | private: |

| | |
|---|---|
| 4 | LUN In; |
| 5 | port pt; |
| 6 | server sv; |

| | |
|---|---|
| 7 | public: |

| 8 | LUN& | getLUN() | {return In;}; |
|---|---|---|---|
| 9 | void | setLUN(LUN& I) | {In = I;}; |
| 10 | port& | getPort() | {return pt;}; |
| 11 | void | setPort(port& p) | {pt = p;}; |
| 12 | server& getServer() | | {return sv;}; |
| 13 | void | setServer(server& s) | {sv = s;}; |

| 14 | AccessEntry& operator=(AccessEntry& ae); | |
|---|---|---|
| 15 | bool | operator==(AccessEntry& ae); |
| 16 | bool | operator<(AccessEntry& ae); |
| 17 | bool | operator>(AccessEntry& ae); |

| | |
|---|---|
| 18 | AccessEntry(LUN& I, port& p, server& s); |
| 19 | AccessEntry(); |

| | |
|---|---|
| 20 | }; |
| 21 | class AccessTable |
| 22 | { |
| 23 | private: |

| | |
|---|---|
| 24 | AccessEntry table[TableLength]; |
| 25 | int size; |

| | |
|---|---|
| 26 | public: |

| 27 | int addEntry(LUN& I, port& p, server& s); | |
|---|---|---|
| 28 | int deleteEntry(LUN& I, port& p, server& s); | |
| 29 | int findEntry(LUN& I, port& p, server& s); | |
| 30 | bool | retrieveEntry(int index, LUN& I, port& p, server& s); |

| | |
|---|---|
| 31 | AccessTable(); |

| | |
|---|---|
| 32 | }; |

The class “AccessEntry,” declared above on lines 1-20, represents a single entry within an access table. As discussed above, each entry in an access table includes an indication of a particular LUN, a port, and a server, or remote computer. Those indications are represented in the class “AccessEntry” by the three data members “In,” “pt,” and “sv,” declared above on lines 4-6. The class “AccessEntry” includes member functions for retrieving and storing values in the three data members, declared above on lines 8-13, an assignment operator and various relational operators, declared above on line 14 and lines 15-17, respectively, and several constructors, declared above on lines 18-19. Note that, in accordance with C++ convention, a function that retrieves the value of a data member has a name that includes the prefix “get,” and a function that stores a value into a data member has a name that includes the prefix “set.” The assignment operator, declared above on line 14, allows one instance of the class “AccessEntry” to be assigned the value of another instance of the class “AccessEntry.” The relational operators, declared above on lines 15-17, allow the values represented by one instance of the class “AccessEntry” to be compared to the values stored within another instance of the class “AccessEntry.”

The class “AccessTable,” declared above on lines 21-32, represents an access table used by an implementation of a disk array controller for storing authorizations for access by particular servers via particular ports to particular LUNs and CDLUNs. An instance of the class “AccessTable” includes an array of instances of the class “AccessEntry,” essentially representing LUN/port/server triples. The array of instances of the class “AccessEntry,” called “table,” is declared above on line 4, and, on line 5, an integer data member “size” is declared that contains the number of valid entries currently stored within the access table represented by an instance of the class “AccessTable.” Note that, in the current implementation, instances of the class “AccessEntry” are stored sequentially in the table starting with the first slot within the table having index “0.” Thus, a table with two valid entries will include instances of the class “AccessEntry” in slots of the table having indices 0 and 1, and the data member “size” will have the value 2. Thus, size represents both the number of valid entries within the table and the index of the next free slot within the table that can be assigned a LUN/port/server triple. The class “AccessTable” includes the following member functions: (1) “addEntry,” a member function declared above on line 27 that adds a LUN/port/server triple to the access table represented by an instance of the class “AccessTable;” (2) “deleteEntry,” a member function declared on line 28 that deletes a particular LUN/port/server triple from the access table; (3) “findEntry,” a member function declared on line 29 that returns the index of a particular LUN/port/server triple stored within the access table; (4) “retrieveEntry,” a member function declared on line 30 that retrieves a LUN/port/server triple from the table entry having index supplied in the argument “index” into the instances of classes “LUN,” “port,” and “server” supplied as reference arguments “l,” “p,” and “s;” and (5) a constructor declared above on line 31.

Next, implementations of various member functions of classes “LUN,” “port,” and “server” are provided. These implementations are quite straightforward, although, in many cases, far from optimally efficient. In the development of control logic and program code, there are commonly many tradeoffs between run-time efficiency, and design and implementation efficiencies, run-time efficiency and code complexity, and run-time efficiency versus economics of maintenance and subsequent enhancement. For illustrative purposes, we have chosen simple algorithms, but not necessarily optimally efficient algorithms, favoring simplicity over run-time efficiency, although many other tradeoffs and corresponding implementations may be chosen, and are within the scope of the present invention. Many of the member function implementations in this section and in a following section are straightforward, and will not be discussed at length.

| | |
|---|---|
| 1 | LUN::LUN() |
| 2 | { |
| 3 | } |
| 4 | port::port() |
| 5 | |
| 6 | } |
| 7 | server::server() |
| 8 | { |
| 9 | } |
| 10 | server& server::operator=(char* s) |
| 11 | { |

| | |
|---|---|
| 12 | char* k = name; |
| 13 | for (int i = 0; i <WWW_name_length; i++) *k++ = *s++; |
| 14 | return *this; |

| | |
|---|---|
| 15 | } |
| 16 | server& server::operator=(server& s) |
| 17 | { |

| | |
|---|---|
| 18 | char* s1 = s.getVal(); |
| 19 | char* k = name; |
| 20 | for (int i = 0; i < WWW_name_length; i++) *k++ = *s1++ |
| 21 | return *this; |

| | |
|---|---|
| 22 | } |
| 23 | bool server::operator==(server& s) |
| 24 | { |

| | |
|---|---|
| 25 | char* s1 = s.getVal(); |
| 26 | char* k == name; |
| 27 | for (int i = 0; i < WWW_name_length; i++) |
| 28 | { |

| | |
|---|---|
| 29 | if (*k++ != *s1++) return false; |

| | |
|---|---|
| 30 | } |
| 31 | return true; |

| | |
|---|---|
| 32 | } |
| 33 | bool server::operator<(server& s) |
| 34 | { |

| | |
|---|---|
| 35 | char* s1 = s.getVal(); |
| 36 | char* k = name; |
| 37 | for (int i = 0; i < WWW_name_length; i++) |
| 38 | { |

| | |
|---|---|
| 39 | if (*k < *s1) return true; |
| 40 | else if (*k++ > *s1++) return false; |

| | |
|---|---|
| 41 | } |
| 42 | return false; |

| | |
|---|---|
| 43 | } |
| 44 | bool server::operator>(server& s) |
| 45 | { |

| | |
|---|---|
| 46 | char* s1 = s.getVal(); |
| 47 | char* k = name; |
| 48 | for (int i = 0; i < WWW_name_length; i++) |
| 49 | { |

| | |
|---|---|
| 50 | if (*k > *s1) return true; |
| 51 | else if (*k++ < *s1++) return false; |

| | |
|---|---|
| 52 | } |
| 53 | return false; |

| | |
|---|---|
| 54 | } |
| 55 | server::server(server& s) |
| 56 | { |

| | |
|---|---|
| 57 | char* s1 = s.getVal(); |
| 58 | char* k = name; |
| 59 | for (int i = 0; i < WWW_name_length; i++) *k++ = *s1++ |

| | |
|---|---|
| 60 | } |
| 61 | server::server (char* s) |
| 62 | { |

| | |
|---|---|
| 63 | char* k = name; |
| 64 | for (int i = 0; i < WWW_name_length; i++) *k++ = *s++ |

| | |
|---|---|
| 65 | } |

The implementation of the server assignment operator, shown above on lines 10-15, typifies implementation of an assignment operator. In this case, the value stored in the data member “name” is assigned to have the value represented by a character string passed to the assignment function as argument “s.” In the for-loop of line 13, the character string referenced by argument “s” is copied to the data member “name,” referenced by the local variable “k.” Finally, the assignment function returns a reference to the current instance of the class “server” on line 14.

The implementation of the server “<” relational operator, shown above on lines 33-43 typifies implementation of a relational operator. This operator compares the value of a current instance of the class “server” to that of a different server instance referenced by reference argument “s.” If the value of the current instance of class “server” is less than that of the server instance referenced by argument “s,” then the “<” operator returns a true Boolean value, and otherwise returns a false Boolean value. In the for-loop of lines 37-41, the value of the data member “name” of the current instance is compared to that of the server instance referenced by argument “s.” The implemented comparison is equivalent to the classical lexical string comparison that produces the familiar ordering of names in a telephone book.

Next, implementations of various member functions of the class “AccessEntry” are provided:

| | |
|---|---|
| 1 | AccessEntry& AccessEntry::operator=(AccessEntry& ae) |
| 2 | { |

| | |
|---|---|
| 3 | In = ae.getLUN(); |
| 4 | pt = ae.getPort(); |
| 5 | sv = ae.getServer(); |
| 6 | return *this; |

| | |
|---|---|
| 7 | } |
| 8 | bool AccessEntry::operator==(AccessEntry& ae) |
| 9 | { |

| | |
|---|---|
| 10 | return (ae.getLUN() == In && |

| | |
|---|---|
| 11 | ae.getPort() == pt && |
| 12 | ae.getServer() == sv); |

| | |
|---|---|
| 13 | } |
| 14 | bool AccessEntry::operator<(AccessEntry& ae) |
| 15 | { |

| | |
|---|---|
| 16 | if (In < ae.getLUN()) return true; |
| 17 | else if (In == ae.getLUN()) |
| 18 | { |

| | |
|---|---|
| 19 | if (pt < ae.getPort()) return true; |
| 20 | else if (pt == ae.getPort()) |
| 21 | { |

| | |
|---|---|
| 22 | if (sv < ae.getServer()) return true; |
| 23 | else return false; |

| | |
|---|---|
| 24 | } |
| 25 | else return false; |

| | |
|---|---|
| 26 | } |
| 27 | else return false; |

| | |
|---|---|
| 28 | } |
| 29 | bool AccessEntry::operator>(AccessEntry& ae) |
| 30 | { |

| | |
|---|---|
| 31 | if (In > ae.getLUN()) return true; |
| 32 | else if (In == ae.getLUN()) |
| 33 | { |

| | |
|---|---|
| 34 | if (pt > ae.getPort()) return true; |
| 35 | else if (pt == ae.getPort()) |
| 36 | { |

| | |
|---|---|
| 37 | if (sv > ae.getServer()) return true; |
| 38 | else return false; |

| | |
|---|---|
| 39 | } |
| 40 | else return false; |

| | |
|---|---|
| 41 | } |
| 42 | else return false; |

| | |
|---|---|
| 43 | } |
| 44 | AccessEntry::AccessEntry(LUN& I, port& p, server& s) |
| 45 | { |

| | |
|---|---|
| 46 | In= I; |
| 47 | pt= p; |
| 48 | sv = s; |

| | |
|---|---|
| 49 | } |
| 50 | AccessEntry::AccessEntry() |
| 51 | { |
| 52 | } |

Next, implementations of various member functions of the class

“AccessTable” are provided below:

| | | |
|---|---|---|
| 1 | int | AccessTable::addEntry(LUN& I, port& p, server& s) |
| 2 | { | |

| | |
|---|---|
| 3 | int i= 0; |
| 4 | int j; |
| 5 | AccessEntry ae(I, p, s); |
| 6 | if (size == TableLength) return −1; |
| 7 | while (i < size && table[i] < ae) i++; |
| 8 | if (i < size && table[i] == ae) return −2; |
| 9 | else |
| 10 | { |

| | |
|---|---|
| 11 | for (j = size; j > i; j−−) table[j] = table[j−1]; |
| 12 | table[i] = ae; |
| 13 | size++ |

| | |
|---|---|
| 14 | } |
| 15 | return size; |

| | |
|---|---|
| 16 | } |
| 17 | int AccessTable::deleteEntry(LUN& I, port& p, server& s) |
| 18 | { |

| | |
|---|---|
| 19 | int i, j; |
| 20 | i = findEntry(I, p, s); |
| 21 | if(i >= 0) |
| 22 | { |

| | |
|---|---|
| 23 | j = i+1; |
| 24 | while (j < size) table[i++] = table[j++]; |
| 25 | size−−; |
| 26 | return size; |

| | |
|---|---|
| 27 | } |
| 28 | return −1; |

| | |
|---|---|
| 29 | } |
| 30 | int AccessTable::findEntry(LUN& I, port& p, server& s) |
| 31 | { |

| | |
|---|---|
| 32 | int i = 0; |
| 33 | AccessEntry ae(I, p, s); |
| 34 | while (i < size && table[i] < ae) i++; |
| 35 | if (i < size && table[i] == ae) return i |
| 36 | else return −1; |

| | |
|---|---|
| 37 | } |
| 38 | bool AocessTable::retrieveEntry(int index, LUN& I, port& p, server& s) |
| 39 | { |

| | |
|---|---|
| 40 | if (index >= 0 && index < size) |
| 41 | { |

| | |
|---|---|
| 42 | I = table[index].getLUN(); |
| 43 | p = table[index].getPort(); |
| 44 | s = table[index].getServer(); |

| | |
|---|---|
| 45 | return true; |

| | |
|---|---|
| 46 | } |
| 47 | else return false; |
| 48 | } |
| 49 | AccessTable::AccessTable() |
| 50 | { |

| | |
|---|---|
| 51 | size = 0; |

| | |
|---|---|
| 52 | } |

Again, implementations of the AccessTable member functions are straightforward and only the implementation of AccessTable member function “addEntry” will be discussed as a representative example. Member function “addEntry” receives reference arguments that reference a LUN, port, and server that are to be added to the access table as a triple represented by an instance of the class AccessTable. On line 5, the local variable “ae” is constructed to contain the LUN/port/server triple specified by the reference arguments. If the access table is full, as detected by addEntry on line 6, then no antry is added an a negative value is returned. In the while-loop of line 7, addEntry scans the valid entries within the table for an instance of the class “AccessEntry” with a value greater than or equal to that of local variable “ae,” as defined by the AccessEntry relational operator “<.” At the conclusion of the while-loop, the local variable “i” is either the offset of the first valid entry greater than or equal to the value of local variable “ae” or the offset of the next available entry within the table. If an entry exists in the table and represents the same triple as represented by local variable “ae,” as detected by addEntry on line 8, then addEntry returns a negative value, since there is no point adding a second equivalent triple to the access table. Otherwise, in the for-loop on line 12, addEntry moves all entries that will follow the entry to be added downward by one place in the table to make space for the new entry, and adds the new entry on line 13. Following addition of the new entry, addEntry increments the value in data member “size” to reflect the new size of the access table.

With the declarations and implementations provided above, the following function “currentAuthorization” is provided to illustrate a current authorization technique employed in certain currently available disk array controllers:

| | |
|---|---|
| 1 | boolcurrentAuthorization (LUN& CDLUN, port& p, server& s, |

| | |
|---|---|
| 2 | AccessTable& at) |

| | |
|---|---|
| 3 | { |

| | |
|---|---|
| 4 | if (at.findEntry(CDLUN, p, s) >= 0) |

| | |
|---|---|
| 5 | return true; |

| | |
|---|---|
| 6 | else return false; |

| | |
|---|---|
| 7 | } |

The function “currentAuthorization” may be called by code within the disk array controller to check whether a requested operation is authorized, in this case, an operation against a target CDLUN that includes specification of additional LUNs, such as a mirroring or backup request discussed earlier. The function “currentAuthorization” receives reference arguments that refer to a LUN, port, server, and access table, “CDLUN,” “p,” “s,” and “at,” respectively. The function currentAuthorization, on line 4, calls the access table member function “findEntry” to determine whether the access table currently includes an entry representing the LUN/port/server triple CDLUN/p/s. If so, then function “currentAuthorization” returns true, on line 5, and otherwise returns false on line 6. Thus, as discussed earlier, the current authorization technique involves checking whether the target CDLUN, port through which the request was received, and unique identifier of the requesting server, or remote computer, occurs as a triple in the authorization table, and, if so, considers the requested operation to be authorized. However, as discussed above, this authorization technique is quite deficient, because the authorized operation may involve accessing LUNs which the requesting server does not have authorization to access, leading to potential corruption of data or reading of data belonging to an organization external to that of the requesting server.

One embodiment of the current invention employs the above declarations and implementations of the LUN, port, server, accessEntry and accessTable classes, along with two additional classes provided below:

| | |
|---|---|
| 1 | class SupplementalAccessEntry |
| 2 | { |
| 3 | private: |

| | |
|---|---|
| 4 | LUN In; |
| 5 | LUN cd; |

| | |
|---|---|
| 6 | public: |

| | | | |
|---|---|---|---|
| 7 | LUN& | getLUN() | {return In;}; |
| 8 | void | setLUN(LUN& I) | {In = I;}; |
| 9 | LUN& | getCDLUN() | {return cd;}; |
| 10 | void | setCDLUN(LUN& I) | {cd = I;}; |

| 11 | SupplementalAccessEntry& operator=(SupplementalAccessEntry& ae); | |
|---|---|---|
| 12 | bool | operator==(SupplementalAccessEntry& ae); |
| 13 | bool | operator<(SupplementalAccessEntry& ae); |
| 14 | bool | operator>(SupplementalAccessEntry& ae); |

| | |
|---|---|
| 15 | SupplementalAccessEntry(LUN& I, LUN& c); |
| 16 | SupplementalAccessEntry(); |

| | |
|---|---|
| 17 | }; |
| 18 | class SupplementalAccessTable |
| 19 | { |
| 20 | private: |

| | |
|---|---|
| 21 | SupplementalAccessEntry table[TableLength]; |
| 22 | int size; |

| | |
|---|---|
| 23 | public: |

| | | |
|---|---|---|
| 24 | int | addEntry(LUN& I, LUN& c); |
| 25 | int | deleteEntry(LUN& I, LUN& c); |
| 26 | int | findEntry(LUN& I, LUN& c); |
| 27 | bool | retrieveEntry(int index, LUN& I, LUN& c); |

| | |
|---|---|
| 28 | SupplementalAccessTable(); |

| | |
|---|---|
| 29 | }; |

The class “SupplementalAccessEntry” is analogous to the previously described class “AccessEntry,” and the class “SupplementalAccessTable” is analogous to the previously described class “AccessTable.” A SupplementalAccessEntry presents a CDLUN/LUN pair and a SupplementalAccessTable includes a number of CDLUN/LUN pairs. As discussed earlier, the presence of a particular CDLUN/LUN pair indicates that the CDLUN may access the LUN as part of an operation for which the CDLUN is the target CDLUN. The two new classes are quite similar to the previously declared classes “AccessEntry” and “AccessTable,” and will therefore not be further described. Implementations of SupplementalAccessEntry and SupplementalAccessTable member functions are provided below:

| | |
|---|---|
| 1 | SupplementalAccessEntry& |
| 2 | SupplementalAccessEntry::operator=(SupplementalAccessEntry& ae) |
| 3 | { |

| | |
|---|---|
| 4 | In = ae.getLUN(); |
| 5 | cd = ae.getCDLUN(); |
| 6 | return *this; |

| | |
|---|---|
| 7 | } |
| 8 | bool SupplementalAccessEntry::Operator==(SupplementalAccessEntry& ae) |
| 9 | { |

| | |
|---|---|
| 10 | return (In == ae.getLUN() && cd == ae.getCDLUN()); |

| | |
|---|---|
| 11 | } |
| 12 | bool SupplementalAccessEntry::operator<(SupplementalAccessEntry& ae) |
| 13 | { |

| | |
|---|---|
| 14 | if (In < ae.getLUN()) return true; |
| 15 | else if (In == ae.getLUN()) |
| 16 | { |

| | |
|---|---|
| 17 | if (cd < ae.getCDLUN()) return true; |
| 18 | else return false; |

| | |
|---|---|
| 19 | } |
| 20 | else return false; |

| | |
|---|---|
| 21 | } |
| 22 | bool SupplementalAccessEntry::operator>(SupplementalAccessEntry& ae) |
| 23 | { |

| | |
|---|---|
| 24 | if (In > ae.getLUN()) return true; |
| 25 | else if (In == ae.getLUN()) |
| 26 | { |

| | |
|---|---|
| 27 | if (cd > ae.getCDLUN()) return true; |
| 28 | else return false; |

| 29 | | } |
|---|---|---|
| 30 | | else return false; |
| 31 | } | |
| 32 | SupplementalAccessEntry::SupplementalAccessEntry(LUN& I, LUN& c) | |
| 33 | { | |
| 34 | | In = I; |
| 35 | | cd = c; |
| 36 | } | |
| 37 | SupplementalAccessEntry::SupplementalAccessEntry() | |
| 38 | { | |
| 39 | } | |
| 40 | int | SupplementalAccessTable::addEntry(LUN& I, LUN& c) |

| | |
|---|---|
| 41 | { |

| | |
|---|---|
| 42 | int i = 0; |
| 43 | int j; |
| 44 | SupplementalAccessEntry ae(I, c); |
| 45 | if (size == TableLength) return −1; |
| 46 | while (i < size && table[i] < ae) i++; |
| 47 | if (i < size && table[i] == ae) return −2; |
| 48 | else |
| 49 | { |

| | |
|---|---|
| 50 | for (j = size; j > i; j−−) table[j] = table[j−1]; |
| 51 | table[i] = ae; |
| 52 | size++; |

| | |
|---|---|
| 53 | } |
| 54 | return size; |

| | |
|---|---|
| 55 | } |
| 56 | int SupplementalAccessTable::deleteEntry(LUN& I, LUN& c) |
| 57 | { |

| | |
|---|---|
| 58 | int i, j; |
| 59 | i = findEntry(I, c); |
| 60 | if (i >= 0) |
| 61 | { |

| | |
|---|---|
| 62 | j = i+1; |
| 63 | while (j < size) table[i++] = table[j++]; |
| 64 | size−−; |
| 65 | return size; |

| | |
|---|---|
| 66 | } |
| 67 | else return −1; |

| | |
|---|---|
| 68 | } |
| 69 | int SupplementalAccessTable::findEntry(LUN& I, LUN& c) |
| 70 | { |

| | |
|---|---|
| 71 | int i = 0; |
| 72 | SupplementalAccessEntry ae(I, c); |
| 73 | while (i < size && table[i] < ae) i++; |
| 74 | if (i < size && table[i] == ae) return i; |
| 75 | else return −1; |

| | |
|---|---|
| 76 | } |
| 77 | bool SupplementalAccessTable::retrieveEntry(int index, LUN& I, LUN& c) |
| 78 | { |

| | |
|---|---|
| 79 | if (index >= 0 && index < size) |
| 80 | { |

| | |
|---|---|
| 81 | I = table[index].getLUN(); |
| 82 | c = table[index].getCDLUN(); |
| 83 | return true; |

| | |
|---|---|
| 84 | } |
| 85 | else return false; |

| | |
|---|---|
| 86 | } |
| 87 | SupplementalAccessTable::SupplementalAccessTable() |
| 88 | { |

| | |
|---|---|
| 89 | size = 0; |

| | |
|---|---|
| 90 | } |

In view of the pseudocode declarations and implementations of classes “SupplementalAccessEntry” and “SupplementalAccessTable,” an authorization function “newAuthorization” that represents one embodiment of the present invention can now be provided:

| | |
|---|---|
| 1 | boolnewAuthorization (LUN& CDLUN, LUN* LUNlist, int listSize, |

| | |
|---|---|
| 2 | port& p, server& s, AccessTable& at, |
| 3 | SupplementalAccessTable& st) |

| | |
|---|---|
| 4 | { |

| | |
|---|---|
| 5 | if (at.findEntry(CDLUN, p, s) >= 0) |
| 6 | { |

| | |
|---|---|
| 7 | while (listSize > 0) |
| 8 | { |

| | |
|---|---|
| 9 | if (st.findEntry(CDLUN, *LUNlist) < 0) return false; |
| 10 | listSize−−; |
| 11 | LUNlist++; |

| | |
|---|---|
| 12 | } |
| 13 | return true; |

| | |
|---|---|
| 14 | } |
| 15 | else return false; |

| | |
|---|---|
| 16 | } |

This new authorization function receives the following arguments: (1) “CDLUN,” a reference to a LUN that represents a target CDLUN of an operation; (2) “LUNlist,” a pointer to a list of LUNs also included in the operation, such as LUNs to be mirrored in a mirroring operation; (3) “listSize,” an integer specifying the number of LUNs in the list “LUNlist;” (4) “p,” the port through which the request for operation was received by the disk array controller (5) “s,” the server, or remote computer, from which the request was received; (6) “at,” a reference to an access table; and (7) “st,” a reference to a supplemental access table. First, on line 5, newAuthorization determines whether the triple CDLUN/p/s currently occurs within the access table, just as in line 4 of the previous authorization technique embodied in the function “currentAuthorization,” described above. If not, then newAuthorization returns a Boolean false value on line 15, since the requesting server does not have authorization to request an operation against the target CDLUN specified by reference argument “CDLUN.” Otherwise, in the while-loop of lines 7-12, newAuthorization checks each LUN in the list “LUNlist” for authorization. On line 9, newAuthorization determines whether the SupplementalAccessTable “st” includes the pair CDLUN/LUN selected from LUNlist. If not, then the target CDLUN of the operation is not authorized to access one of the LUNs specified for the operation, and newAuthorization returns the Boolean value false on line 9. If CDLUN/LUN pairs for each LUN in the list “LUNlist” are found in the while-loop of lines 7-12, then the operation is authorized, and newAuthorization returns the Boolean value true on line 13.

Thus, the above-described embodiment of the present invention adds a second access table, the supplemental access table, to the firmware implementation of the disk array controller, providing the disk array controller with the ability to conduct a more thorough authorization check for requests by remote computers for operations against target CDLUNs that include specification of additional LUNs. The new authorization technique involves checking for authorization of the requesting remote computer requests an operation against the specified target LUN, as well as checking that the specified target CDLUN is authorized to access the additionally specified LUNs of the request. By using a two-tiered authorization mechanism, the described embodiment of the present invention closes a significant security hole that formerly existed in disk array controller implementations and in the implementations of controllers of many other types of mass storage devices. The authorized entities in the above-described embodiment are remote computers, but other entities such as remote processes or users may be authorized in alternative embodiments.

Although the present invention has been described in terms of a particular embodiment, it is not intended that the invention be limited to this embodiment. Modifications within the spirit of the invention will be apparent to those skilled in the art. For example, the present invention may be employed in implementations of controllers for a wide variety of mass storage devices remotely accessed by high-speed communications media, such as a fibre channel. As noted above, the present invention may be implemented in hardware circuitry, firmware, or software, depending on the nature of the implementation of the controller of the mass storage device in which the present invention is employed. As with any software implementation, the present invention may be implemented in an almost limitless number of different ways. Different control structures and modular organizations may be employed, different table formats with different basic operations may be employed, and the present invention may be implemented in any number of different programming or specification languages. The described embodiment is implemented within a disk array controller, but alternative embodiments may be implemented within authorization routines that run on remote computers that access a mass storage device, within authorization servers, or in other types of devices and systems.

The foregoing description, for purposes of explanation, used specific nomenclature to provide a thorough understanding of the invention. However, it will be apparent to one skilled in the art that the specific details are not required in order to practice the invention. The foregoing descriptions of specific embodiments of the present invention are presented for purpose of illustration and description. They are not intended to be exhaustive or to limit the invention to the precise forms disclosed. Obviously, many modifications and variations are possible in view of the above teachings. The embodiments are shown and described in order to best explain the principles of the invention and its practical applications, to thereby enable others skilled in the art to best utilize the invention and various embodiments with various modifications as are suited to the particular use contemplated. It is intended that the scope of the invention be defined by the following claims and their equivalents:

1. A method for authorizing access by remote entities to logical units provided by a mass storage device comprising:
providing an access table that includes entries that each represents authorization of a particular remote entity to access a particular logical unit;
providing a supplemental access table that includes entries that each represents authorization of a particular control device logical unit to access a particular logical unit; and
when a remote entity requests execution of an operation directed to a specified control device logical unit and involving one or more additional specified logical units,
authorizing the request for execution of the operation only when an entry currently exists in the access table that represents authorization of the remote entity to access the specified control device logical unit and, for each of the one or more additional specified logical units, an entry exists in the supplemental access table that represents authorization of the specified control device logical unit to access the additional specified logical unit.

2. The method of claim 1 wherein the mass storage device includes ports through which requests from remote entities are received, and wherein authorizing a request for execution is carried out by a controller within the mass storage device.

3. The method of claim 2 wherein the access table includes entries each comprising:
an indication of a logical unit or control device logical unit;
an indication of a port; and
an indication of a remote entity.

4. The method of claim 2 wherein the supplemental access table includes entries each comprising:
an indication of a control device logical unit; and
an indication of a logical unit.

5. The method of claim 2 wherein the mass storage device is a disk array and remote entities are remote computers interconnected with the disk array via a communications medium.

6. An authorization system for authorizing access by remote entities to logical units provided by a mass storage device comprising:
a request detecting component that detects requests for execution of an operation generated by a remote entity;
an access table that includes entries that each represents authorization of a particular remote entity to access a particular logical unit;
a supplemental access table that includes entries that each represents authorization of a particular control device logical unit to access a particular logical unit; and
control logic that authorizes a request made by a remote entity, detected by the request detecting component, directed to a specified control device logical unit and involving one or more additional specified logical units only when an entry exists in the access table that represents authorization of the remote entity to access the specified control device logical unit and, for each of the one or more additional specified logical units, an entry exists in the supplemental access table that represents authorization of the specified control device logical unit to access the additional specified logical unit.

7. The system of claim 6 wherein the mass storage device includes ports through which requests from remote entities are received, and wherein the control logic resides within the mass storage device.

8. The system of claim 7 wherein the access table includes entries each comprising:
an indication of a logical unit or control device logical unit;
an indication of a port; and
an indication of a remote entity.

9. The system of claim 7 wherein the supplemental access table includes entries each comprising:
an indication of a control device logical unit; and
an indication of a logical unit.

10. The system of claim 7 wherein the mass storage device is a disk array and remote entities are remote computers interconnected with the disk array via a communications medium.
